(19) United States
(12) Patent Application Publication
(10) Pub. No.: US 2005/0223636 A1
(43) Pub. Date: Oct. 13, 2005

(54) Weaning mat

(76) Inventors: Anthony L. Schmitt, St. Cloud, MN (US); Darryl L. Metcalfe, Albany, MN (US)

Correspondence Address: Schwegman, Lundberg, Woessner & Kluth, P.A., P.O. Box 2938, Minneapolis, MN, 55402, US

(21) Appl. No.: 11/091,695

(22) Filed: Mar. 28, 2005

Related U.S. Application Data
(60) Provisional application No. 60/521,354, filed on Apr. 8, 2004.

(51) Int. Cl. A01C 1/04

(52) U.S. Cl. 47/56

(57) ABSTRACT

The invention described herein includes a biodegradable weaning mat comprising a biodegradable main body.

### RELATED APPLICATION

This application claims the benefit of U.S. Provisional Application Ser. No. 60/521,354 filed Apr. 8, 2004, which application is incorporated by reference and made a part hereof.

### FIELD OF THE INVENTION

Embodiments of the invention relate to a disposable, biodegradable mat for weaning piglets and other young animals and to a method for making the biodegradable mat.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any software and data as described below and in the drawings that form a part of this document: Copyright 2005, USA Solutions, Inc. All Rights Reserved.

### BACKGROUND OF THE INVENTION

Modern swine husbandry allows for piglets to be weaned from a sow at a young age of three weeks or less. To achieve this goal, it is imperative that the piglets begin eating solid feed in the form of pellets or crumbles within this three week period. One method used to start piglets on feed has been to sprinkle small quantities of solid feed in an area where the piglets rest.

The resting area for these small pigs has typically included a soft mat made of rubber or similar materials. When feed is sprinkled on the mat, however, the food rolls or is pushed off the mat edge where it then falls through perforated flooring that typically surrounds the mat. Significant quantities of feed are required to replace the feed that falls through the perforated flooring, Furthermore, pathogens from the feed, the piglet and the external environment tend to reside on the rubber mat and put the piglet at risk of disease.

### BRIEF DESCRIPTION OF THE DRAWINGS

FIG. 1 illustrates a perspective view of a weaning mat of the invention described herein.

FIG. 2 illustrates a cross-sectional view of the weaning mat of the invention described herein.

FIG. 3 illustrates a bottom plan view of the weaning mat of FIG. 1.

### DESCRIPTION

Methods, apparatus and systems for extraction of a variety of materials from biomass are described herein. In the following description, numerous specific details are set forth. However, it is understood that embodiments of the invention may be practiced without these specific details. In other instances, well-known circuits, processes, structures, and techniques have not been shown in detail in order to avoid obscuring the understanding of this description. Note that in the description, references to “one embodiment” or “an embodiment” mean that the feature being referred to is included in at least one embodiment of the invention. Further, separate references to “one embodiment” in this description do not necessarily refer to the same embodiment; however, neither such embodiments are mutually exclusive, unless so stated and except as will be readily apparent to those of ordinary skill in the art. Thus, the invention described herein may include any variety of combinations and/or integrations of the embodiments described herein. Moreover, in this description, the phrase “exemplary embodiment” means that the embodiment being referred to serves as an example or illustration.

The term “wean” as used herein refers to action taken to cause a baby or young animal to stop feeding on its mother's milk and to start eating other food.

The term “farrow” as used herein refers to the birth of a litter of piglets.

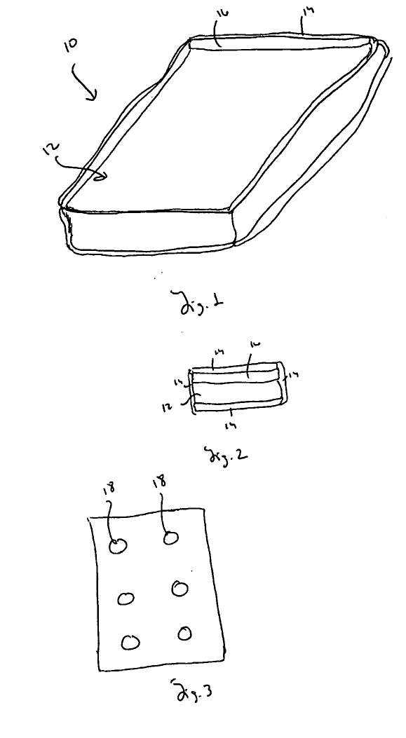

One embodiment of the weaning mat of the invention described herein, illustrated in a perspective view, generally at 10 in FIG. 1, includes a biodegradable main body 12. Some embodiments further include one or more biodegradable film layers 14 overlaying the main body 12. The weaning mat 10 additionally includes, for some embodiments, a border 16 for preventing feed from rolling off the mat. The mat 10 additionally includes one or more corners 18 on a bottom surface of the mat. The corners aid in keeping the mat 10 in place when in use. For some embodiments, the corners 18 include an adhesive that aids in keeping the mat in place. The mat 10 is fire resistant using

While a weaning mat is described, it is understood that the mat embodiments have uses as farrowing mats, nursery mats and other mats for small animals. While a weaning mat for piglets is described, it is understood that mat embodiments are suitable for other animals in addition to piglets as well and use is not limited to piglets. Additionally, while young animals are described herein, it is believed that mat embodiments are suitable for use by small animals of any age.

The film 14 and the main body 12 are made of one or more of a variety of materials in such a manner that upon exposure to natural environmental conditions, such as ultraviolet solar radiation, moisture, or dirt, the weaning mat 10 quickly oxidizes, degrades, disintegrates, melts or otherwise decomposes to leave products harmless to, or beneficial to, the natural environment. Such breakdown products are non-toxic to animals and plants and do not contaminate water supplies, soil or other parts of the ecological system. Weaning mat such as is shown at 10 are both biodegradable and compostable.

In one embodiment, the mat breaks down within 7 to 10 days of use as a weaning mat by piglets. Over the 7 to 10 days, however, the mat is resistant to being torn or other deterioration. After the 7 to 10 day usage period has past, the mat 10 is discarded to waste where it quickly degrades in a manner that does not harm the natural environment. While a 7 to 10 day usage period is described herein, it is understood that mat embodiments may be made degradable after other periods of usage.

The mat, when used for piglet weaning, in one embodiment, has dimensions of 2 feet by 4 feet. Other mat embodiments have dimensions of 4 feet by 6 feet and are 3/16 to ¼ inch thick. In another farrowing mat embodiment, the mat has dimensions of 30 inches by 36 inches and has thickness of ⅛ to ¼ inches. In a nursery mat embodiment, the mat has dimensions of 4 feet by 5 feet. While these dimensions are described, it is understood that other dimensions are usable to make embodiments of the mat of the invention described herein.

The mat 10 is, for some embodiments, black in color and has a rough surface. For other embodiments, the mat is green in color. While black and green are described, it is believed that any dark color is suitable for use. The dark color absorbs heat from heat lamps used to warm the young animals and further warms the animals. For some embodiments, the mats are soft and provide young animals with a comfort greater than what is provided by conventional rubber mats.

For other embodiments, the surface is smooth and for other embodiments, the surface is a combination of rough and smooth. The border 16 has dimensions of about 3/16 to ¼ inch in height and about ½ inches wide.

In one embodiment, the main body 12 and, optionally, border 16 are a foamed material that includes one or more of a vegetable starch, such as corn or potato starch, or a grain starch, such as wheat starch. The foam provides a cushion for the piglets and the cellular structure of the foam accelerates degradation of the mat once the film breaks down. For this embodiment, each of the film layers 14 and the main body 12 includes one or more of the following materials: (1) a biodegradable resin; (2) gelatin; (3) a polyester; (4) cellulose; (5) modified cellulose; (6) a starch; (7) a modified starches; (8) gelatins; (9) casein; or (10) a biodegradable plastic. In a particular embodiment of the invention, at least one of the mat's layers is made of vegetable starch, such as corn or potato starch, or grain starch (such as wheat starch). While the materials described herein are included in some weaning mat embodiments, it is understood that other materials aiding in biodegradation are suitable for use in the invention.

In one embodiment, the mat 10 is made of a mixture that includes 50 percent corn stalk particles and 50 percent wood chip particles. Other suitable materials for the mixture include biodegradable particle products such as wheat, straw, and so forth, which are all bi-products of crops grown by farmers.

In one embodiment, the mixture adheres by a hot melt in an oven at 375 degrees Fahrenheit, to make the mat.

In another embodiment wherein the mat includes one or more film layers, the film layers include water degradable polymers that are characterized by being soluble or dispersible in water or swellable in water, or by having 20 tensile properties, such as tensile strength and modulus, which drop substantially when the polymer, in the form of a film, is wetted with water. When dry, however, the water degradable polymer holds shape and has integrity as a film. Water-degradable polymers include water soluble and water dispersible polymers which disintegrate in water. Desirably, the water degradable polymers disintegrate in water over the 7 to 10 day interval. Suitable water degradable polymers include polyethylene oxide (PEO), copolymers of polyethylene oxide and polypropylene oxide, other water dispersible ethylene oxide copolymers, water dispersible blends of 30 polyethylene oxide, water degradable grades of polyvinyl alcohol, blends of polyvinyl alcohol, polyethyloxazoline, water degradable branched polyesters and copolyesters, water dispersible polyurethanes, water degradable acrylic acid based copolymers, water dispersible polyvinyl methyl ether, cellulose derivatives such as methyl cellulose, hydroxypropyl cellulose, methylated hydroxypropyl cellulose, hydroxypropyl methyl cellulose and ethyl cellulose, and the like. One water-degradable polymer for making the water degradable microlayer polymer film is PEO. Grafted or chemically modified PEO is also suitable. The film layers coat the main body 12 and the border 16.

In another embodiment, the water degradable polymer films are interspersed with water resistant layers. For this embodiment, the water degradable polymer film degrades rapidly but degradation is slowed by a water resistant layer. With this embodiment, an alternating layer system degrades over the 7 to 10 day period of mat usage.

In another embodiment, the mat layer includes a hydrogel that degrades over the 7 to 10 day period of usage. In one other embodiment, the mat layer includes capsules that rupture and accelerate mat degradation over the 7 to 10 day usage period.

In another embodiment, the mat 10 includes a main body but does not include a film. In one other embodiment, the border 16 includes a film but the main body 12 does not include a film. The main body for this embodiment is made from one or more of the following materials: (1) biodegradable resin; (2) gelatin; (3) polyester; (4) cellulose; (5) modified cellulose; (6) starch; (7) modified starch; (8) gelatin; (9) Casein; or (10) biodegradable plastic.

In an embodiment of the invention, the mat is made of vegetable starch, such as corn or potato starch, or grain starch, such as wheat starch. In another embodiment, the mat includes filler particles. These filler particles are typically biodegradable and include, for example, peat moss, vermiculite, straw, or fertilizer. Many other types of biodegradable materials may be used as filler particles. Such filler particles are either beneficial to the environment (e.g., promote the growth of grass or inhibit the growth of weeds), or at least do not harm the environment.

Materials for the mat are selected to produce a mat of a desired density. For some embodiments, the mat is manufactured to have a relatively dense solid consistency by use of relatively dense plastic resin or gelatin. Alternatively, for other embodiments, the mat is manufactured to have a relatively low-density consistency. For some embodiments, the mat includes a foam material such as a foam resin or starch.

In one embodiment of the invention, the mat is made of a vegetable starch foam, such corn starch foam. Using a less-dense material is advantageous for some embodiments of mat construction for two reasons. First, using a less-dense material to make a mat of a standard size reduces the weight of the mat. In addition, generally speaking, the less dense the mat material is, the faster it will decompose. This is because, generally speaking, the less dense a material is, the less total material needs to be broken down before the material fully decomposes.

For some embodiments, mats are sprayed or coated with a material that imparts waterproofing, fire resistance, or other type of protection.

The weaning mats described herein are an improvement over conventional rubber mats. Embodiments of the weaning mats are softer and, because, they are biodegradable, much more sanitary than rubber mats. Furthermore, rubber mats are difficult or impossible to disinfect. Even after high pressure washing with disinfectants, bacteria and other pathogens remain on the rubber mats.

By baking the biodegradable mats at 370 degrees prior to use, bacteria and other pathogens in the mats are killed. The combination of features of mat sterility and mat biodegradability and mat compostability renders mat embodiments described herein safer for use with young animals. The animals are not put at risk of disease from the mats themselves.

As will be understood by one skilled in the art, when the mat includes a foam resin, the density of the foam may be varied by changing the amount of air mixed into the resin during fabrication. That is, the foam density is dependent upon the resin-to-air ratio used during mixing and injection. This density can be varied to manipulate the final decomposition rate of the mat. Generally speaking, the higher the resin-to-air ratio of a particular foam, the greater the density of the foam will be, and the slower the foam will biodegrade. Similarly, the lower the resin-to-air ratio for a particular foam, the more quickly the foam will biodegrade.

The density of a mat comprised of a resin foam may also be varied (as described above) to determine the final weight and hardness of the mat. Generally speaking, the greater the resin-to-air ratio of a particular foam, the greater the weight and hardness of the mat will be. If the resin- to-air ratio is lowered, the foam will be less dense, and the mat will be lighter and softer.

Having described and illustrated the principles of the invention in particular embodiments thereof, it should be apparent that the invention can be modified in arrangement and detail without departing from such principles. The scope of the invention is intended to be limited only by the claims appended hereto.

1. A biodegradable weaning or farrowing mat comprising a biodegradable main body.

2. The biodegradable weaning or farrowing mat of claim 1 wherein the mat degrades after 7 to 10 days of use.

3. The biodegradable weaning or farrowing mat of claim 1 wherein the weaning or farrowing mat further comprises one or more films that overlay the biodegradable main body.

4. The biodegradable weaning or farrowing mat of claim 1 wherein the mat has a dark color.

5. The biodegradable weaning or farrowing mat of claim 1 wherein the main body comprises corn stalk particles and wood chips.

6. A method for weaning a small animal without producing a non biodegradable waste product, comprising:
providing the mat of claim 1 and weaning a small animal using the mat.

7. The method of claim 4, further comprising disposing of the mat.

8. A method for farrowing without producing a non biodegradable waste product, comprising: providing the mat of claim 1 and farrowing an animal.

9. A weaning enclosure comprising the weaning or farrowing mat of claim 1.

10. A farrowing enclosure comprising the weaning or farrowing mat of claim 1.

11. A nursery enclosure comprising the weaning or farrowing mat of claim 1.
